(19) United States
(12) Patent Application Publication
(10) Pub. No.: US 2024/0043201 A1
(43) Pub. Date: Feb. 8, 2024

(54) BEVERAGE PAD

(71) Applicant: Koninklijke Douwe Egberts B.V., Utrecht (NL)

(72) Inventors: Richard John Andrews, Utrecht (NL); Roman Amaury Thibaut Pichot, Capelle aan den IJssel (NL); Leon Bernard Oudehand, Weert (NL); Hendrika Johanna Maria Van Den Elzen, Houten (NL); Jente Marieke Andriessen, Utrecht (NL); Demet Sekerci, Dordrecht (NL); Gabriela Cadore Pimentel, Nieuwegein (NL)

(21) Appl. No.: 18/266,577

(22) PCT Filed: Dec. 13, 2021
(86) PCT No.: PCT/NL2021/050761

§ 371 Date: Jun. 9, 2023

(30) Foreign Application Priority Data
Dec. 11, 2020 (EP) 20213581.0
Aug. 5, 2021 (EP) 21189957.0

(51) Int. Cl. B65D 85/804; B65D 65/46; A23F 5/12; A47J 31/36; A47J 31/06; A47J 31/08

(52) U.S. Cl. CPC B65D 85/8046; B65D 65/466; A23F 5/125; A47J 31/368; A47J 31/0668; A47J 31/085

(57) ABSTRACT

A beverage pad (100) for use in a beverage preparation machine for preparing a beverage comprises an amount of extractable and/or soluble beverage preparation product in a compacted puck (130) enclosed between two sheets of filtering material (110, 120) sealed to each other at a periphery edge of the pad. A first sheet of the two sheets has a bottom portion, side portion and a first edge portion. A second sheet of the two sheets comprises a central portion and a second edge portion. The edge portions of the sheets are sealed to each other forming the periphery edge of the pad. The side portion, bottom portion and central portion define a space holding the compacted puck (130) of extractable and/or soluble beverage preparation product which has a uniform thickness. The bottom portion and central portion are at least substantially flat and parallel to each other on opposite sides of the compacted puck, and the side portion extends perpendicular from the bottom portion around the compacted puck (130) to the periphery edge.

### FIELD OF THE INVENTION

The invention relates to a beverage pad. The invention further relates to an assembly of a beverage pad and a pad holder for accommodating the beverage pad for use in a beverage preparation machine. The invention also relates to a puck of extractable beverage substance for making beverage pads.

### BACKGROUND

Beverage pads are well known consumption articles that may be used in a beverage preparation machine for preparing a consumable beverage such as a coffee, tea, chocolate or milk based beverage. Usually a beverage pad comprises an amount of extractable and/or soluble beverage preparation product enclosed between two sheets of filtering material, which allows a beverage to be prepared by supplying the pad in the beverage preparation machine with an aqueous fluid to extract or solubilize the beverage preparation product. For example a coffee beverage may be prepared from a beverage pad comprising an amount of extractable coffee product, e.g. ground coffee, between two sheets of filtering material. Such pads are known to comprise the beverage preparation product held between the two sheets in a relatively loose form, for instance for preparing a drip-style, American-style or brewed coffee beverage, or an espresso-style coffee or lungo-style coffee beverage.

Available beverage pads are produced by providing two sheets of filtering material with a first sheet of the two sheets shaped to form a pouch-like bottom portion, side portion and a first edge portion defining a space for receiving a bed of beverage product in loose form. A second sheet of the two sheets of filtering material may be applied with a central portion thereof over the bed of beverage product opposite the bottom portion to cover the beverage product on both sides and with a second edge portion of the second sheet attached, e.g. by sealing, to the first edge portion of the first sheet to form the beverage pad with the beverage product packaged between the two sheets of filtering material.

The shaping of the first sheet is usually realized by feeding the sheet along a surface provided with a recess as mold in which a flexible piece of the sheet is shaped either by suction of the flexible piece of the filtering material in the recess, e.g. by using suction means, or by pressing the flexible piece of the filtering material in the recess. In practice elastic properties of the sheet of filtering material together with stretch applied to the flexible piece upon suction or pressing thereof in the recess or mold results for both these methods in that the first sheet obtains a pouch-like form having a clear sloped or curved transition between the bottom portion and side portion due to elastic deformation of the filtering material upon removal of the suction or pressing force. When depositing the bed of beverage product on the first sheet this creates a non-uniform thickness in the bed of beverage product, i.e. a thickness of the bed of beverage product nearer to a side portion of the pad above the sloped or curved part of the first sheet is less than a thickness of the pad nearer to a central portion of the pad above the bottom portion. Such non-uniform thickness of the bed of beverage product may affect the beverage quality of the beverage prepared. Particularly, the non-uniform thickness may cause bypass of fluid when supplying an aqueous fluid to the pad, with a portion of the supplied aqueous fluid flowing through the thinner parts of the pad carrying little to no extracted and/or solubilized beverage preparation product. As a consequence consistency of extraction between pads may be less than desired, and the extraction may not be optimal. Bypass may be visually detectable at the start of a beverage preparation, for example during the first few seconds of fluid dispensing, as watery liquid being dispensed from the beverage machine. The resulting beverage may be too watery in appearance and/or taste, i.e. having a discolored crema, diluted aroma's, and/or have less than appreciated or non-optimal ‘strength’.

Most of the beverage pads are intended for single serve, meaning that with a single pad a single serving of a beverage can be prepared in the beverage preparation machine. There are also beverage preparation machines that allow the use of multiple beverage pads in a single beverage preparation process to produce a bigger variety of beverage types or beverage volumes. For example the use of two beverage pads placed on top of each other in a brewing chamber of a suitable beverage preparation machine is known and allows for more variation in beverage to be produced as compared to using a single pad. For example the beverage preparation product in the two beverage pads may be different, e.g. with one of the two pads comprising an extractable beverage preparation product such as ground coffee and the other of the two pads comprising a soluble beverage preparation product such as milk powder. The two pads may also comprise the same beverage preparation product, for example ground coffee, for instance to prepare a larger volume of beverage. In such cases using two pads or more the bypass occurring for each of the pads individually may accumulate and lead to an even more pronounced watery beverage.

In order to produce a beverage the beverage pads are generally manually put in a brew chamber of a beverage preparation machine by a user, usually in an assembly together with a pad holder which supports the pad in the brew chamber. However, in practice the known pads may be positioned in a less than optimal way, i.e. misplaced, in the brew chamber and/or on the pad holder, which further leads to even more bypass occurring when preparing a beverage.

It is an aim of the present invention to provide a high quality beverage pad. Particularly the present invention aims to provide a beverage pad that ameliorates the drawback of the known beverage pads. A particular aim of the invention is to provide a beverage pad which in use for preparing a beverage produces less bypass. A more specific aim of the invention is to provide a beverage pad which is less prone to being misplaced in the brew chamber by a user, reducing the occurrence of bypass when preparing a beverage. A further aim of the present invention is to provide an assembly of a beverage pad and pad holder for use in a beverage preparation machine to prepare a beverage with less bypass. It is another aim of the present invention to provide a high quality compacted puck for use in a beverage pad.

### DESCRIPTION OF THE INVENTION

According to a first aspect there is provided a beverage pad for use in a beverage preparation machine for preparing a beverage by supplying the pad in the machine with a pressurized aqueous fluid of between 1-20 bar, preferably 1-2 bar, comprising an amount of extractable and/or soluble beverage preparation product in a compacted puck enclosed between two sheets of filtering material sealed to each other at a periphery edge of the pad, a first sheet of the two sheets having a bottom portion, side portion and a first edge portion, a second sheet of the two sheets comprising a central portion and a second edge portion, the edge portions of the sheets sealed to each other forming the periphery edge of the pad, and the side portion, bottom portion and central portion defining a space holding the compacted puck of extractable and/or soluble beverage preparation product, wherein the compacted puck has a uniform thickness with the bottom portion and central portion being at least substantially flat and parallel to each other on opposite sides of the compacted puck, and the side portion extending at least almost perpendicular from the bottom portion around the compacted puck to the edge portions.

The pad according to this first aspect can be produced by supplying the compacted puck to a packaging device comprising a body, e.g. a rotating cylindrical body such as a rotating drum, with an outer surface having recesses for receiving in each recess a first sheet of filtering material, a bottom wall of each recess formed by a respective movable piston arranged to move with respect to the outer side surface of the moving body to vary a height of the recess in relation to a position of the recess on the moving body such as an angular position of the recess on the circular circumference of the cylindrical body. The packaging device can be arranged with the outer surface of the body below a puck forming device to directly receive pucks formed by the puck forming device on the first sheet of filtering material in each recess of the further rotating drum. To this end the body is preferably arranged to be driven with a moving speed of the outer surface adapted to the puck forming speed of the puck forming device such that each puck formed in and provided by the puck forming device is received in a corresponding recess of the body. The movable piston of each recess may be used to release a packaged puck from the respective recess, e.g. the piston pushes the packaged puck out of the recess by moving the piston from a retracted position to a position closer to the outer surface of the body. Particularly a filtering material feed station of the packaging device may feed a first continuous sheet of filtering material to a rotating cylindrical body with impressions being provided in the continuous sheet of filtering material in a respective recess of the cylindrical body to receive in each impression a compacted puck of beverage preparation product delivered by the puck forming device. The movable piston of each recess in the body may be arranged to be driven to move in dependence of its angular position on the circular circumference of the cylindrical body between a first state defining a first height of the respective recess for receiving the first sheet of filtering material in the respective recess with an impression having a corresponding height dimension which is larger than a thickness of each compacted puck of beverage preparation product delivered by the puck forming device, and a second state defining a second height of the respective recess smaller than the first height for forming the first sheet of filtering material in the respective recess with an impression shaped to approximately match a shape of each compacted puck of beverage preparation product. Thus the apparatus is configured to receive a piece of the first sheet of filtering material in the recess with the first height, which height compared to a thickness of the puck formed by the puck forming device is over dimensioned. After filling the recess with a puck the piston may be moved to the second state to provide said piece of first sheet shaped to approximately match a shape of the compacted puck of beverage preparation product. The reduction of the height of the recess in the second state after initially over dimensioning the piece of the first sheet in the recess may be adapted to compensate for any elastic deformation of the piece of the first sheet, thus allowing for shaping the piece of the first sheet tightly around the puck with bottom portion and side portion remaining angled at least almost straight or 90°. Accordingly the apparatus enables producing the beverage pads with uniform thickness with negligible to no rounded or sloped transition between the bottom portion and side portion by packaging a compacted puck with uniform thickness between such shaped piece of the first sheet and a second sheet that can be applied over the compacted puck opposite the bottom portion.

Alternatively, the puck can be produced by supplying ground coffee to a packaging device comprising a moving belt with recesses for receiving in each recess a first sheet of filtering material. After filling the ground coffee is compacted and a second sheet of filtering material is put on top of the recesses, whereby the edge portions of the sheets are sealed to each other forming the periphery edge of the pad.

As the puck has a uniform thickness and is tightly packaged in filtering material extending around the puck with side portion being at least nearly perpendicular to the bottom portion there are no relevant rounded or sloped parts or other thickness irregularities in the pad. In use the beverage pad provides improved consistency of beverage quality, as well as improved beverage quality, particularly with respect to extraction characteristics, as occurrence of bypass when supplying an aqueous fluid through the pad is minimized or completely prevented.

In an embodiment of the pad the sheets and the compacted puck are configured and arranged to at least substantially maintain a shape of the compacted puck with uniform thickness in use of the beverage pad in the beverage preparation machine when exposed to the aqueous fluid under pressure. For example the puck may be produced with a compaction force of between 2-8 kN, preferably between 3-6 kN, most preferably about 4 kN. In the case of a puck preparation device, such as the rotating cylindrical body, the compacting force may preferably be between 4 and 6 kN. In the case of a puck preparation device, such as the moving belt, the compacting force may preferably between 2 and 4 kN. It will be understood that a desired compressive pressure for producing the puck may be predetermined and selected in dependence on the actual beverage preparation product. A compressive force of at least 2 kN is found to provide a sturdiness to the produced puck sufficient to maintain a uniform thickness of the puck in use of the beverage pad. Above 6 kN compressive pressure the compaction of the beverage preparation product results in a puck that when used in a beverage preparation machines forms such a high flow resistance to the supplied fluid that the pad in some of the available beverage preparation machines may be practically unusable due to unacceptable long preparation times and/or prepared beverage characteristics being less than desired such as the occurrence of over extraction resulting in for example bitter flavors and aromas.

In a particular embodiment the pad may comprise the second sheet consisting of a substantially flat piece of filtering material having a central region forming the central portion and a peripheral portion forming the second edge portion. Such substantially flat piece of filtering material can be produced relatively conveniently and at relative low cost by cutting the second sheet out of a larger sheet of filtering material, e.g. a sheet provided as a roll of filtering material.

A further embodiment of the pad comprises the puck tightly enclosed by the first sheet and second sheet with a volume of the puck being at least substantially identical to a volume of the space defined by the sheets. Thus the space defined by the sheets is at least almost completely filled up by beverage preparation product. As such there is no free space in the pad possibly affecting the fluid flow through the pad or providing other irregularities which may lower the reproducibility of beverage results obtained with such pads.

One or more of the sheets of the pad may be formed by a relatively rigid body. Preferably at least one of the first sheet and second sheet is a flexible sheet of filtering material, preferably both sheets are flexible. For example at least one of the first sheet and the second sheet is made of a compostable filtering material, preferably a non-woven material and/or fibrous material, preferably a filtering paper. Preferably both the first sheet and second sheet are made of a compostable filtering material, preferably a non-woven material and/or fibrous material, preferably a filtering paper. Most preferably the first sheet and second sheet are made of the same material.

In an embodiment of the pad the bottom portion of the first sheet is configured as a liquid discharge side of the pad. For example the bottom portion of the first sheet may comprise openings or may be porous to allow discharge of the beverage liquid from the beverage pad in use.

A particular embodiment of the pad has the bottom portion, side portion and first edge portion of the first sheet integrally formed and made from one piece. The first sheet may for instance be molded and cut as a single piece out of a larger sheet of filtering material. Preferably the first sheet is formed from one piece with a right angle, i.e. 90°, between the bottom portion and side portion. Alternatively the first sheet may be formed by attaching an initially separate bottom portion and side portion to each other, for example by means of welding, with the side portion extending at least almost perpendicular to the bottom portion.

In a preferred embodiment, large sheets of filtering material are used for both forming the first sheet and the second sheet, the edge portions of the sheets sealed to each other forming the periphery edge of the pad and then cut to form the pad.

In an embodiment of the pad the first sheet has a grammage of between 30-40 grams per square meter (gsm), preferably 35 gsm. This grammage, which is higher than the grammage of the first sheet of average conventional beverage pads, results in a first sheet sufficiently thick and strong to maintain an integrity and shape of the pad in use in preparing a beverage. Optionally the first sheet has a grammage of 36 gsm.

Optionally, the pad comprises the central portion of the second sheet configured as a liquid inlet side of the pad. In use of the pad fluid supplied by the beverage preparation machine to the pad enters through the liquid inlet side, which to this end may comprise openings or may be porous.

In an embodiment of the pad the second sheet may have a grammage of between 15-20 gsm, preferably 19 gsm. This grammage is sufficient for the filtering material to form a suitable inlet side of the pad. The first sheet and the second sheet may optionally have the same grammage, i.e. the same weight. However, preferably the first sheet forming a discharge side of the pad has a higher grammage, i.e. has a higher weight, as compared to the second sheet forming an inlet side of the pad. Particularly, the first sheet is preferably thicker than the second sheet. The first sheet is optionally larger than the second sheet. Preferably the bottom portion of the first sheet and the central portion of the second sheet are approximately equal in size.

In a particular embodiment of the pad the puck consists of a compacted layer of ground coffee. Thus the pad may be used for producing a coffee beverage, such as a drip-style, American-style or brewed coffee beverage, and is particularly suited for preparing an espresso-style coffee or lungo-style coffee beverage.

In a particular embodiment, the puck comprises 6.5 to 7.5 g ground coffee, preferably 7 g. Optionally, the ground coffee has a moisture content of 3 to 5%, preferably 4.5%. Optionally, the puck has a layer of ground coffee comprising or mainly consisting of ground coffee with a grind size (×50) between 250-500 μm, preferably between 300-360 μm, such as 310, 320, 340 or 350 μm, to be particularly suited for an espresso-style coffee beverage or between 430-470 μm, such as 440, 450 or 460 μm, to be particularly suited for a lungo-style coffee beverage. Preferably, the layer of ground coffee comprises an amount of fines, i.e. particles with a grind size <100 μm, of at most 20% by volume of the total amount of grinds, preferably below 16% by volume of the total amount of grinds, preferably a minimum of 10% by volume of the total amount of grinds. The compaction force employed to produce the compacted puck of beverage preparation product may be suited to the specific grind size and fines content of the beverage preparation product. However in a particular embodiment the pad has the compacted puck having a bulk density of between 350-450 g/L, preferably a bulk density between 390-405 g/L, more preferably 395-400 g/L or 365-390 g/L, more preferably 375-385 g/L. Optionally the bulk density is between 370-400 g/L. In a preferred embodiment the bulk density is between 380-390 g/L.

In an embodiment of the pad the compacted puck has a uniform thickness of between 6-7.5 mm, preferably 6.5-7.2, more preferably 6.8 mm. Optionally the pad has a compacted puck with a uniform thickness of 7 mm.

A further embodiment of the pad has the compacted puck shaped as a circular disc with a diameter of between 50-60 mm, preferably 55 mm. These sizes for thickness and diameter of the puck provides a good fit of the pad in most available beverage preparation machines. In particular, the diameter of the puck is adapted to fit on most of the available pad holders such that a risk of incorrect positioning of the pad in the brew chamber is reduced.

In an embodiment of the pad the diameter of the pad at its bottom portion defined by the first sheet is between approximately 50-60 mm, preferably approximately 55 mm, and corresponding to the diameter of the compacted puck and two times a thickness of the side portion of the first sheet.

Optionally the pad has a diameter at its periphery edge of between 60-65 mm, preferably between 61-63 mm, and more preferably 62 mm.

Preferably the pad has the periphery edge uniformly peripherally extending from the side portion over a distance of between 3-4 mm, more preferably 3.5 mm. Thus, a length of the periphery edge is preferably between 3-4 mm, more preferably 3.5 mm. The periphery edge of a pad when placed by a user on most available pad holders, particularly available pad holders for using double pads one on top of the other, will be slightly bend due to the diameter of the pad at the periphery edge being larger than the diameter of the inner space defined by the pad holder in which the pad is positioned at the height of the periphery edge. The bend poses tension in the periphery edge. If the periphery edge is relatively long, i.e. longer than 4 mm, the corresponding relative high tension in the periphery edge in most pad holders will increase a likelihood that the pad slightly moves on the pad holder prior to or upon closure of the machine. This causes the pad in use to often become incorrectly positioned resulting in more bypass. This is particularly noticeable when preparing beverages using double pads, one on top of the other, with the lower of the two pads being very prone to movement prior to use. A shorter flange provides less strain/tension so that the pad is less likely to move with less bypass as a result. Good positioning results on most of the available pad holders were achieved with the periphery edge not longer than 4 mm. A periphery edge shorter than 3 mm however renders it more difficult to manufacture the pad, particularly in respect of a desirable sealing between the first sheet and second sheet. Good positioning and bypass results, i.e. hardly any bypass, was achieved on most available pad holders with the pad having the periphery edge with a length of 3.5 mm.

Desirable positioning and bypass results on most available pad holders were achieved with the pad having a compacted puck shaped as a circular disc with a diameter of 55 mm and a periphery edge extending from the puck over a distance of 4 mm resulting in the pad having a diameter at its periphery edge of 63 mm. Good positioning and bypass results for double pads, one on top of the other, on a double pad holder were obtained with the pads each having a compacted puck shaped as a circular disc with a diameter of 55 mm and a periphery edge extending from the puck over a distance of 3.5 mm resulting in the pads having a diameter at the periphery edge of 62 mm, and the pad holder defining an inner space in which the lower of the two pads is positioned which inner space at the height of the periphery edge of the lower pad has a diameter length less than 60.5 mm.

According to a second aspect there is provided an assembly of a beverage pad and a pad holder for accommodating the beverage pad for use in a beverage preparation machine, wherein the pad holder comprises a rigid, form-retaining body with a support surface supporting the beverage pad and with a liquid discharge channel extending through the body from the support surface to a liquid outlet opening, wherein the beverage pad is a beverage pad as described herein.

In an embodiment of the assembly the pad holder is provided with beverage pad positioning means arranged to position and restrict the beverage pad in a predetermined position on the support surface of the pad holder. The assembly is preferably arranged to prevent the pad in use from being erroneously positioned on the support surface or in the brew chamber of the beverage preparation machine. In a correct position of the pad on the pad holder the puck of the pad may be placed at least almost horizontally in the brewing chamber of the beverage preparation machine. Pressurized fluid supplied to the pad will accordingly flow with gravity through the uniform thickness of the puck, reducing any possible occurrence of bypass. Optionally a size of the pad holder and the pad positioning means are adapted to the size of the pad in the assembly.

Optionally the beverage pad positioning means of the pad holder comprise blocking means positioned on a circumference of the support surface and arranged to block lateral movement of the beverage pad supported on the support surface. Particularly the pad positioning means may comprise pad blocking means such as a shoulder, ridge or other fixing means provided at the pad holder support surface which pad blocking means are arranged to fixate a bottom portion of the beverage pad placed on the support surface. For example the pad blocking means may define a recessed part of the pad holder in which the bottom section of the pad is fittingly received when the pad is properly placed on the pad holder. In a particular embodiment of the assembly the pad blocking means comprise a continuous or non-continuous rib or ridge extending from the support surface along the side portion of the pad supported on the support surface towards the edge portions of the pad.

According to a third aspect a method of preparing a beverage is provided, the method comprising the steps of:
arranging a pad as described herein or an assembly as described herein, in a beverage preparation machine comprising a receptacle for accommodating the pad or assembly and a fluid conduit having a first portion for conducting a pressurized fluid to the pad and a second portion for conducting the beverage away from the pad or assembly;
supplying the pressurized fluid via the first portion of the fluid conduit to the pad; and
receiving the beverage in a vessel from the second portion of the conduit.

In an embodiment of the method a pressure of the pressurized fluid supplied by the beverage preparation machine is in the range of 1 to 20 bars, preferably 1 to 2 bars.

According to a fourth aspect a compacted puck for use in a beverage pad is provided, the puck comprising an amount of extractable and/or soluble beverage preparation product in a layer, wherein the puck has one or more of the following features:
the puck comprises 6.5 to 7.5 g ground coffee, preferably 7 g;
the ground coffee has a moisture content of 3 to 5%, preferably 4.5%;
the layer comprises or mainly consists of ground coffee with a grind size (×50) between 250-500 μm, optionally comprising an amount of fines of at most 20% of the total amount of grinds;
a bulk density of between 350-450 g/L;
a uniform thickness of between 6-7.5 mm; and
is shaped as a circular disc with a diameter of between 50-60 mm, preferably 55 mm. The compacted puck preferably allows a beverage pad to be produced that in use in preparing a beverage has less bypass occurring than known beverage pads while a beverage quality of the prepared beverage may be maintained or improved.

According to a fifth aspect a compacted puck for use in a beverage pad is provided, the puck comprising an amount of extractable and/or soluble beverage preparation product in a layer, wherein the puck has one or more of the following features:
the layer comprises or mainly consists of ground coffee with a grind size between 300-360 μm; and
a bulk density of between 390-405 g/L, preferably 395-400 g/L.

This fifth aspect is in particularly suited for an espresso-style coffee beverage, with a volume of between 40 to 60 ml, preferably about 45 ml. According to a sixth aspect a compacted puck for use in a beverage pad is provided, the puck comprising an amount of extractable and/or soluble beverage preparation product in a layer, wherein the puck has one or more of the following features:
the layer comprises or mainly consists of ground coffee with a grind size between 430-470 μm; and
a bulk density of between 365-390 g/L, preferably 375-385 g/L.

This sixth embodiment is in particularly suited for a lungo-style coffee beverage, with a volume between 80 to 110 ml, preferably about 100 ml.

### BRIEF DESCRIPTION OF THE FIGURES

These and other aspects of the present invention are hereinafter further elucidated by the appended drawing and the corresponding embodiments, which form part of the present application. The drawing is not in any way meant to reflect a limitation of the scope of the invention, unless this is clearly and explicitly indicated. In the drawing:

FIG. 1 shows a schematic representation of a beverage pad according to a first aspect described herein, with respectively showing a) exploded view of the pad with a first sheet of material and second sheet of material separate from each other, b) side view of the pad with first sheet of material and second sheet of material sealed to each other, c) bottom view of the pad;

FIG. 2 shows a cross sectional side view of an assembly according to a second aspect described herein with a beverage pad supported on a pad holder;

FIG. 3 shows a cross sectional side view of another assembly according to a second aspect described herein with a beverage pad supported on a pad holder and positioned below a dispensing head of a beverage machine;

FIGS. 4-9 show bar graphs of the percentage of tested beverage pads demonstrating no, initial, medium or full bypass occurring in use in preparing a beverage;

FIGS. 10-15 show bar graphs of the percentage of tested beverage pads demonstrating no, initial, medium or full bypass occurring in use in preparing a beverage in a beverage machine depending on a particular positioning, i.e. way of loading, of the pad in the beverage machine; and

FIGS. 16-21 show bar graphs of the percentage of tested beverage pads demonstrating no, initial, medium or full bypass having normal, slightly white, or white crema layer occurring when preparing a beverage.

In this application similar or corresponding features are denoted by similar or corresponding reference signs. The description of the embodiments is not limited to the examples shown in the figures and the reference numbers used in the detailed description and the claims are not intended to limit the description of the embodiments, but are included to elucidate the embodiments by referring to the examples shown in the figures.

### DETAILED DESCRIPTION OF THE FIGURES

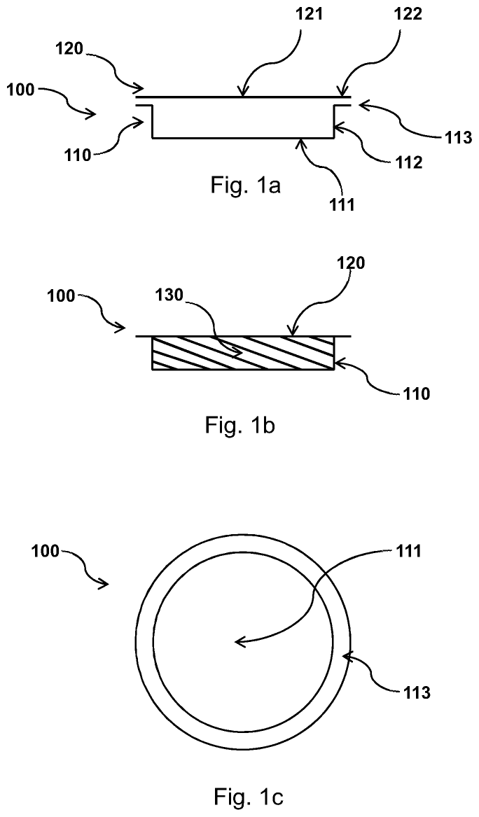

As shown in FIG. 1a,b,c, the beverage pad 100 in accordance with a first aspect described herein comprises a first sheet of filtering material 110 shaped to have a bottom portion 111, side portion 112 and an edge portion 113. The first sheet 110 is made of filtering paper in one piece having a weight of 35 gsm. The beverage pad 100 further comprises a substantially flat piece of a second sheet of filtering material 120 having a central portion 121 and an edge portion 122. The second sheet 120 is made out of one piece of the same filtering paper material as the first sheet 110 but has a weight of 19 gsm. The bottom portion 111, side portion 112, and central portion 121 define and delimit a space holding a compacted puck 130 of ground coffee, although any other extractable and/or soluble beverage preparation product may be used instead. Good results are obtained with the puck 130 having a diameter of 55 mm and a thickness of 6.8 mm, providing the pad with about 7 g ground coffee. The compacted puck 130 has a uniform thickness and is tightly enclosed between the two sheets 110,120 which are sealed to each other at the edge portions 113, 122 with the bottom portion 111 and central portion 121 being parallel to each other on opposite sides of the compacted puck 130. The side portion 112 extends perpendicular between the bottom portion 111 and central portion 121 around the compacted puck 130, with an angle between the bottom portion 111 and side portion 112 being straight, i.e. 90°. The beverage pad 100 when used to prepare a beverage provides a consistent and high beverage quality, as occurrence of bypass through the puck when supplying an aqueous fluid through the pad is minimized or completely prevented.

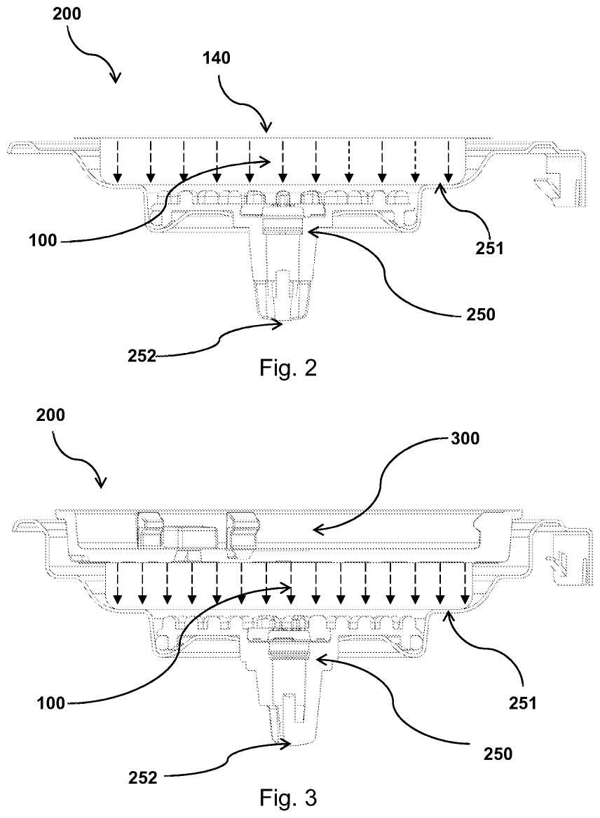

As shown in FIG. 2 the assembly 200 in accordance with a second aspect described herein comprises a beverage pad 100 as described in the foregoing supported on a support surface 251 of a pad holder 250. In use of the assembly in a beverage machine (not shown) a suitable liquid such as water is fed from a dispensing head of the beverage machine to the beverage pad and distributed over the central portion of the second sheet of the pad. In the figure arrows indicate the flow path of the liquid going through the compacted puck of beverage product in the pad. As the liquid is distributed over the central portion of the second sheet, and the puck of beverage product furthermore has a uniform thickness, a flow resistance posed to the liquid by the puck is approximately the same over the entire surface of the puck. Accordingly, a liquid flow volume and rate through the puck will be approximately the same everywhere, with consistent extraction as a result. Particularly the occurrence of liquid bypass is minimized or completely prevented. The resulting beverage is collected in the pad holder 250 below the bottom portion of the first sheet of the beverage pad 100 and may be dispensed via a central outlet opening 252 in the pad holder, for example in a suitable beverage receptacle such as a cup.

As shown in FIG. 3 another assembly 200 in accordance with a second aspect described herein comprises a beverage pad 100 as described in the foregoing supported on a support surface 251 of a pad holder 250. The support surface 251 of the pad holder, i.e. the surface of the pad holder on which the pad is supported, extends into an inclining wall directed towards the edge portions of the beverage pad, which inclining wall assists to correctly position the beverage pad on the support surface 251 upon placement of a beverage pad on the pad holder. In use of the assembly in a beverage machine a suitable liquid such as water is fed from a dispensing head 300 of the beverage machine to the beverage pad and distributed over the central portion of the second sheet of the pad. In the figure arrows indicate the flow path of the liquid going through the compacted puck of beverage product in the pad. The resulting beverage is collected in the pad holder 250 below the bottom portion of the first sheet of the beverage pad 100 and may be dispensed via a central outlet opening 252 in the pad holder, for example in a suitable beverage receptacle such as a cup.

It is to be noted that the figures are only a schematic representation of an embodiment of the invention that is given by way of non-limiting example.

Beverage pads according to the first aspect described herein were tested for an amount of bypass occurring in use in preparing a beverage. The pads either comprised a compacted puck of ground coffee in an espresso blend with a grind size of 300-340 μm, an amount of fines of less than 16% by volume and a bulk density of approximately 395 g/L, the pad hereinafter and in the figures designated as EDR Puck, or a compacted puck of ground coffee in a lungo blend with a grind size of 430-470 μm, an amount of fines of less than 15% by volume and a bulk density of approximately 385 g/L, the pad hereinafter and in the figures designated as Brazil Puck. Both pads comprise a first sheet having a grammage of 35 gsm and a second sheet having a grammage of 19 gsm. Presently available pads of conventional pouch-like design with rounded transition between bottom portion and side portion and having a relatively loose bed of either the espresso blend ground coffee, hereinafter and in the figures designated EDR Pad, or lungo blend ground coffee, hereinafter and in the figures designated Brazil Pad, were similarly tested for bypass results. Two different types of the EDR Pad were tested, a first comprising a first sheet having a grammage of 21 gsm, hereinafter and in the figures designated EDR Pad 1, and a second comprising a first sheet having a grammage of 35 gsm, hereinafter and in the figures designated EDR Pad 2. Also two different types of the Brazil Pad were tested, a first comprising a first sheet having a grammage of 21 gsm, hereinafter and in the figures designated Brazil Pad 1, and a second comprising a first sheet having a grammage of 35 gsm, hereinafter and in the figures designated Brazil Pad 2. In all pads the second sheet has a grammage of 19 gsm.

The pads were tested in a conventional Senseo® beverage preparation machine. A 45 ml beverage was prepared with the EDR pads. A 100 ml beverage was prepared with the Brazil pads.

Bypass was determined by visual inspection of the beverage being discharged from the beverage preparation machine during a preparation cycle as well as the final beverage received in a receptacle after the preparation cycle. The beverage being discharged was investigated for the occurrence of colourless, watery liquid being discharged. If such colourless, watery liquid was observed only in the first second, i.e. <1 s, from the start of observed liquid discharge this was considered as initial bypass occurrence. If such colourless, watery liquid was observed until the fifth second, i.e. >1 s-<5 s, from the start of observed liquid discharge this was considered as medium bypass occurrence. If such colourless, watery liquid was observed for more than five seconds, i.e. >5 s, from the start of observed liquid discharge this was considered as full bypass occurrence. If no such colourless, watery liquid was observed this was considered to represent no bypass occurrence. The final beverage received was further investigated for the occurrence and colour of crema layer being formed on top of the beverage.

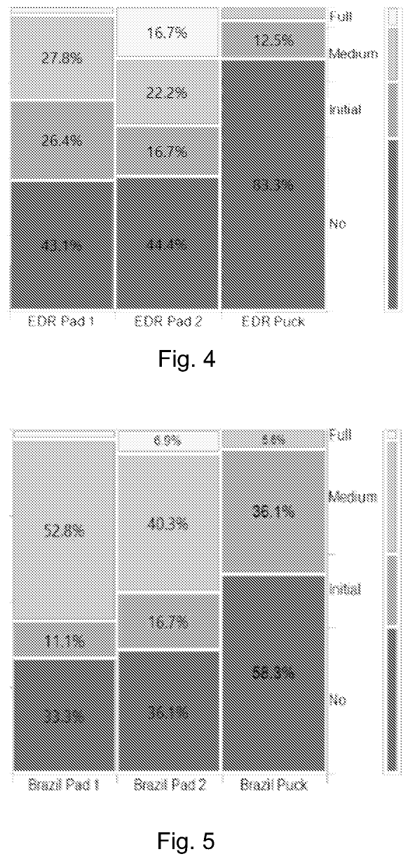

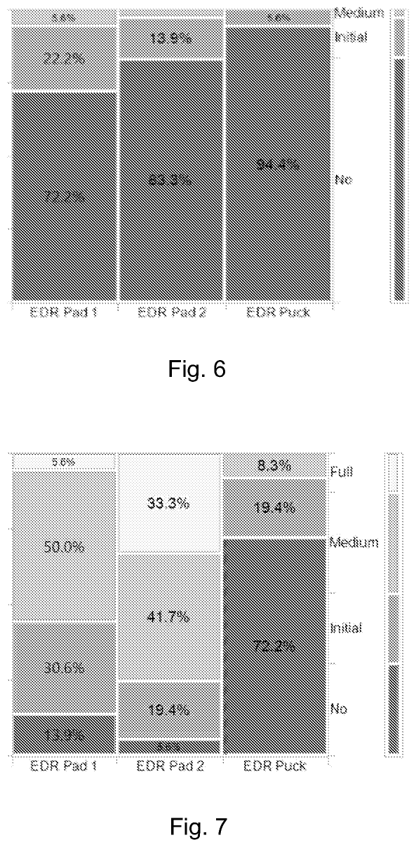

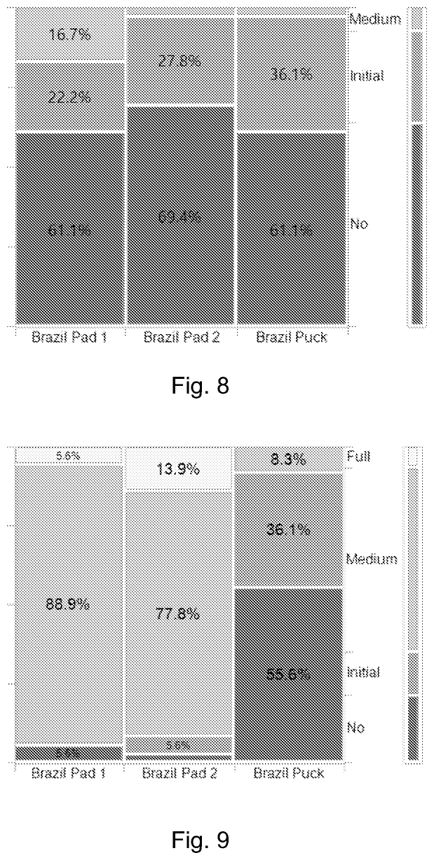

As shown in FIGS. 4-9 the pad according to the first aspect herein demonstrated noticeable less occurrence of bypass compared to the conventional pads. The biggest difference is observed when using double pads in one beverage preparation cycle as shown in FIGS. 7 and 9, with the amount of bypass occurring with conventional pads being pronounced whereas the Puck pads of the first aspect herein had considerable less bypass occurring.

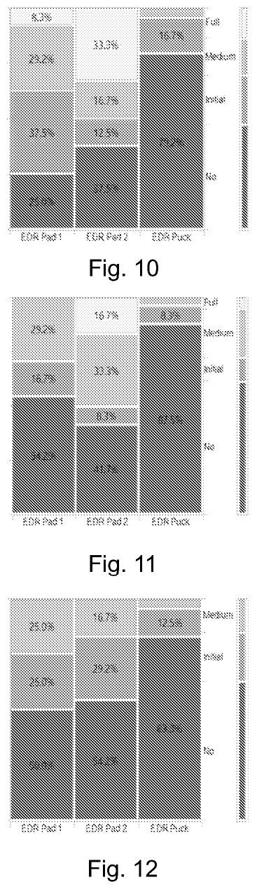

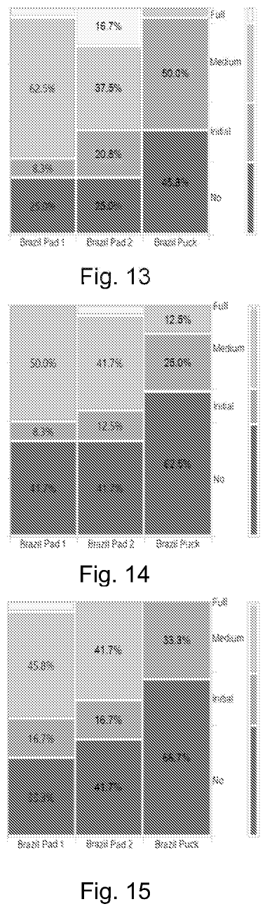

As shown in FIG. 10-15 the bypass results in use are affected by the positioning, i.e. way of loading, of a beverage pad in the beverage machine. Particularly the EDR Pads and Brazil Pads demonstrated more initial, medium and full bypass compared to EDR Pucks and Brazil Pucks when not correctly placed on the pad holder centrally in the beverage machine, shown in FIG. 10 and FIG. 13 respectively. Flattening of the beverage pad prior to positioning on the pad holder gives a noticeable reduction in bypass occurrence in both the conventional Pads and Puck, with a majority of the Pucks demonstrating no occurrence of bypass, as shown in FIG. 11 and FIG. 14 for EDR and Brazil respectively. Flattening of the beverage pad after positioning on the pad holder also gives a similar noticeable reduction in bypass occurrence in both the conventional Pads and Puck, with a majority of the Pucks demonstrating no occurrence of bypass, as shown in FIG. 12 and FIG. 15 for EDR and Brazil respectively.

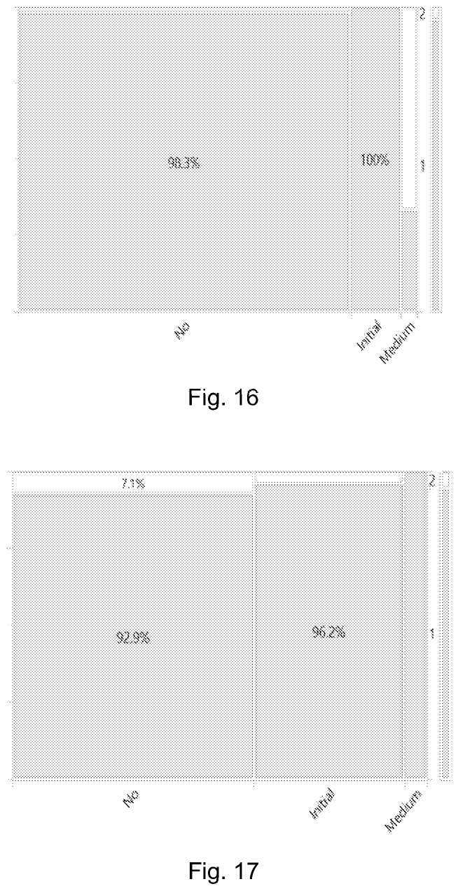

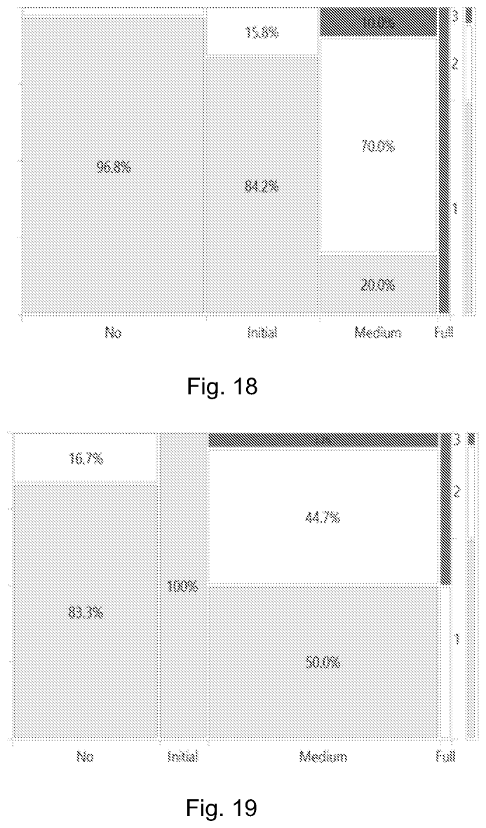

As shown in FIGS. 16-21 the crema layer colour of prepared beverages is strongly associated with bypass occurrence. As particularly shown in FIGS. 16 and 17 respectively, almost all the Puck EDR and Puck Brazil pads that had no bypass or only initial bypass showed a normal crema layer, with the Puck EDR and Puck Brazil pads that had medium bypass occurrence showing some slightly white crema layer. As particularly shown in FIGS. 18 and 19 respectively, similarly almost all the EDR Pad 1 and Brazil Pad 1 that had no bypass or only initial bypass showed a normal crema layer, with the EDR and Brazil Pad 1 that had medium bypass occurrence showing many cases of slightly white crema layer and some cases of white crema layer. The EDR and Brazil Pad 1 that had full bypass occurrence showed in many or all cases white crema layer.

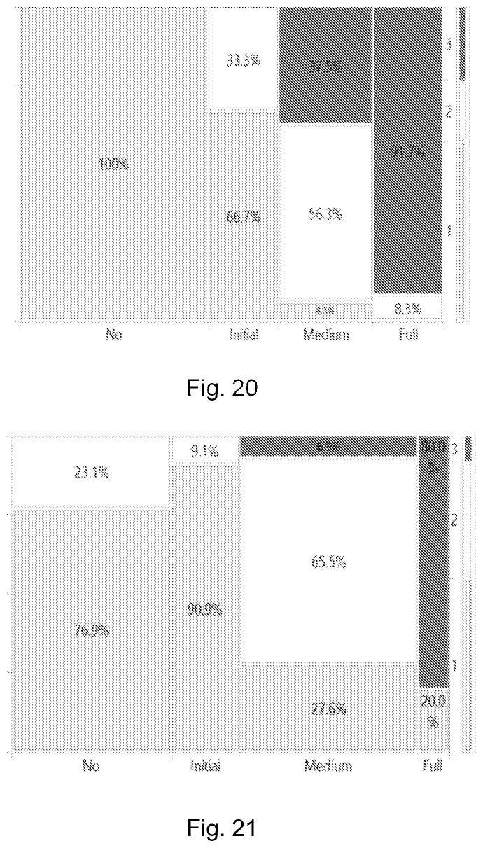

As particularly shown in FIGS. 20 and 21 respectively, similarly almost all the EDR Pad 2 and Brazil Pad 2 that had no bypass or only initial bypass showed a normal crema layer, with the EDR and Brazil Pad 2 that had medium bypass occurrence showing many cases of slightly white crema layer and some cases of white crema layer. The EDR and Brazil Pad 2 that had full bypass occurrence showed in many or all cases white crema layer.

For the purpose of clarity and a concise description, features are described herein as part of the same or separate embodiments, however, it will be appreciated that the scope of the invention may include embodiments having combinations of all or some of the features described.

The word ‘comprising’ does not exclude the presence of other features or steps than those listed in a claim. It also does not exclude that nothing else is present, i.e. it may also encompass the meaning of ‘consisting of. Furthermore, the words ‘a’ and ‘an’ shall not be construed as limited to ‘only one’, but instead are used to mean ‘at least one’, and do not exclude a plurality.

A person skilled in the art will readily appreciate that various parameters and values thereof disclosed in the description may be modified and that various embodiments disclosed and/or claimed may be combined without departing from the scope of the invention.

1. A beverage pad for use in a beverage preparation machine for preparing a beverage by supplying the pad in the machine with a pressurized aqueous fluid of between 1-20 bar, comprising an amount of extractable and/or soluble beverage preparation product enclosed between two sheets of filtering material sealed to each other at a periphery edge of the pad, a first sheet of the two sheets having a bottom portion, side portion and a first edge portion, a second sheet of the two sheets comprising a central portion and a second edge portion, the edge portions of the sheets sealed to each other forming the periphery edge of the pad, and the side portion, bottom portion and central portion defining a space holding the extractable and/or soluble beverage preparation product, wherein the extractable and/or soluble beverage preparation product is in the form of a compacted puck, the compacted puck has a uniform thickness with the bottom portion and central portion being at least substantially flat and parallel to each other on opposite sides of the compacted puck, and the side portion extending at least almost perpendicular from the bottom portion around the compacted puck to the edge portions.

2. Beverage pad according to claim 1, wherein the sheets and the compacted puck are configured and arranged to at least substantially maintain a shape of the compacted puck with uniform thickness in use of the beverage pad in the beverage preparation machine when exposed to the aqueous fluid under pressure, preferably that the puck is tightly enclosed by the first sheet and second sheet with a volume of the puck being at least substantially identical to a volume of the space defined by the sheets.

3.-4. (canceled)

5. Beverage pad according to claim 1, wherein at least one of the first sheet and second sheet is a flexible sheet of filtering material, preferably both sheets are flexible sheets of filtering material.

6. Beverage pad according to claim 3, wherein the first sheet and the second sheet are made of a compostable filtering material, preferably a non-woven material and/or fibrous material, preferably a filtering paper.

7. Beverage pad according to claim 1, wherein the bottom portion of the first sheet is configured as a liquid discharge side of the pad.

8. Beverage pad according to claim 1, wherein the bottom portion, side portion and first edge portion of the first sheet are integrally formed and made from one piece.

9-10. (canceled)

11. Beverage pad according to claim 1, wherein the first sheet has a grammage of between 30-40 grams per square meter (gsm), preferably 35 gsm.

12. Beverage pad according to claim 1, wherein the central portion of the second sheet is configured as a liquid inlet side of the pad.

13. Beverage pad according to claim 1, wherein the second sheet has a grammage of between 15-20 gsm, preferably 19 gsm.

14. Beverage pad according to claim 1, wherein the puck consists of a compacted layer of ground coffee.

15. Beverage pad according to claim 10, wherein the layer of ground coffee comprises or mainly consists of ground coffee with a grind size (×50) between 250-500 μm, preferably between 300-360 μm or between 430-470 μm, and/or
that the layer of ground coffee comprises an amount of fines, i.e. particles with a grind size <100 μm, of at most 20% by volume of the total amount of grinds, preferably below 16% by volume of the total amount of grinds, preferably a minimum of 10% by volume of the total amount of grinds, and/or that the compacted puck has a bulk density of between 350-450 g/L, preferably a bulk density between 390-405 g/L or 375-390 g/L, preferably 375-385 g/L or 395-400 g/L.

16-17. (canceled)

18. Beverage pad according to claim 1, wherein the compacted puck has a uniform thickness of between 6-7.5 mm, preferably 6.5-7.2, most preferably 6.8 mm.

19. Beverage pad according to claim 1, wherein the compacted puck is shaped as a circular disc with a diameter of between 50-60 mm, preferably 55 mm, and/or that the pad has a diameter at its periphery edge of between 60-65 mm, preferably between 61-63 mm, and more preferably 62 mm, and/or that the periphery edge uniformly peripherally extends from the side portion over a distance of between 3-4 mm, more preferably 3.5 mm.

20-21. (canceled)

22. An assembly of a beverage pad and a pad holder for accommodating the beverage pad for use in a beverage preparation machine, wherein the pad holder comprises a rigid, form-retaining body with a support surface supporting the beverage pad and with a liquid discharge channel extending through the body from the support surface to a liquid outlet opening, wherein the beverage pad is a beverage pad according to claim 1.

23-27. (canceled)

28. A compacted puck for use in a beverage pad comprising an amount of extractable and/or soluble beverage preparation product in a layer, wherein the puck has one or more of the following features:
the layer comprises 6.5 to 7.5 g ground coffee, preferably 7 g;
the ground coffee has a moisture content of 3 to 5%, preferably 4.5%;
the layer comprises or mainly consists of ground coffee with a grind size (×50) between 250-500 μm, preferably between 300-360 μm or between 430-470 μm, optionally comprising an amount of fines of at most 20% of the total amount of grinds;
a bulk density of between 350-450 g/L, preferably a bulk density between 390-405 g/L or 365-390 g/L, preferably 375-385 g/L or 395-400 g/L;
a uniform thickness of between 6-7.5 mm, preferably 6.5-7.2 mm, most preferably approximately 6.8 mm; and
is shaped as a circular disc with a diameter of between 50-60 mm, preferably 55 mm.
